(19) United States
(12) Patent Application Publication
(10) Pub. No.: US 2021/0187762 A1
(43) Pub. Date: Jun. 24, 2021

(54) CRUST CUTTER HAVING EXTENDABLE BLADE

(71) Applicants: Yuki SHIMADA, Tokyo (JP); Nami Yamashita, Tokyo (JP); Yui Ogino, Ciba Pref. (JP); Kaito Jingu, Saitama Pref. (JP); Yuuka Sakaguchi, Chiba Pref. (JP); Mizuki Takeda, Saitama Pref. (JP); Sakurako Ishikawa, Miyagi Pref. (JP)

(72) Inventors: Yuki SHIMADA, Tokyo (JP); Nami Yamashita, Tokyo (JP); Yui Ogino, Ciba Pref. (JP); Kaito Jingu, Saitama Pref. (JP); Yuuka Sakaguchi, Chiba Pref. (JP); Mizuki Takeda, Saitama Pref. (JP); Sakurako Ishikawa, Miyagi Pref. (JP)

(21) Appl. No.: 17/123,108

(22) Filed: Dec. 16, 2020

(51) Int. Cl. B26B 1/08; B26B 29/06

(52) U.S. Cl. CPC B26B 1/08; B26B 1/10; B26B 29/063

(57) ABSTRACT

A crust cutter having an extendable blade includes a top plate having a groove at its outer periphery, and having a recess formed in the back surface of the top plate, a handle attached to the top surface of the top plate, a blade insertable to the groove wherein the shape of the blade is the same as that of the top plate, and an extendable blade being stored in the blade, the extendable blade being able to pull out from the blade.

### BACKGROUND OF THE INVENTION

### 1. Fields of the Invention

This invention has been made by the members of MIMURA Seminar, College of Law, Nihon Univ. as a team. This invention relates to a crust cutter having an extendable blade, which can adjust its size to any kinds of a plain bread.

### 2. Background of Invention

Traditionally, in the case that crusts are removed a large specialized device in a bread plant is used, or an ordinary bread knife is used at home. Such a large device is too much large to be placed in a typical home, and since these machines used in the bread plant is specialized for bread companies, it could be used only for bread of predetermined size. In addition, a conventional household crust cutter is not adjustable in length, so it can be used for a particular size of bread. Therefore, in order to enjoy the white bread without crusts, it is necessary to buy some white breads having no crust at a supermarket, but otherwise the crusts should be removed with a regular bread knife. This method was costly and time-consuming because the crust must be cut off one by one with a bread knife.

According to the present invention, the crust of any size bread can be cut off at home by changing the length of the knife for each bread, so it is possible to resolve the problems described above.

### SUMMARY OF THE INVENTION

An object of the present invention is to solved the above problem, and to provide an crust cutter having an extendable blade including a top plate having a groove at its outer periphery, and having a recess formed in the back surface of the top plate, a handle attached to the top surface of the top plate, a blade insertable to the groove wherein the shape of the blade is the same as that of the top plate, and an extendable blade being stored in the blade, the extendable blade being able to pull out from the blade.

### BRIEF DESCRIPTION OF DRAWINGS

The invention will be more described with reference to the accompanying drawings in which:

FIG. 1 shows a perspective view of a crust cutter with an extended blade, according to the present invention;

FIG. 2 shows a lower view of the crust cutter, according to the present invention;

FIG. 3 shows a perspective view of an extendable blade of a the crust cutter when an extendable blade is stored, according to the present invention of the present invention;

FIG. 4 shows a perspective view of an extendable blade when the extendable blade-is extended, according to the present invention;

FIG. 5 shows a perspective view of a mold having convex that can be attached to a recess formed in the crust cutter, according to the present invention; and

FIG. 6 shows an enlarged a cross-sectional view of the extendable blade taken along the line A-A′ shown in FIG. 4.

### DETAILED DESCRIPTION OF THE PREFERRED EMBODIMENT

The preferred embodiment of the present invention is described below together with the drawings. In each drawing, the same reference numbers indicate the same or similar components that pass through all embodiments.

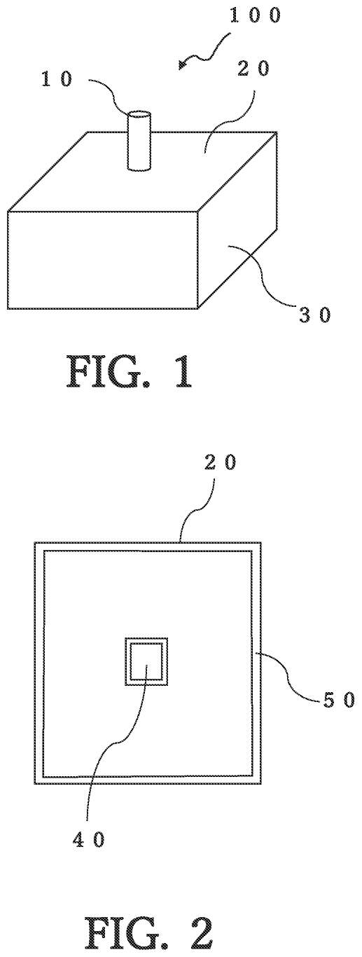

FIG. 1 shows a perspective view of a crust cutter 100 with an extendable blade. The crust cutter 100 includes a handle 10, a top plate 20, a blade 30, and an extendable blade that is stored within the blade 30. In FIG. 1, since the extendable blade 60 is stored in the blade 30, it is not illustrated, and is illustrated in FIG. 4.

The invention relates to the cutter specialized for cutting crusts, and is possible to quickly remove only the crusts with the extendable blade whose length is adjustable. For ease of use, the handle 10 is placed in the approximate center of the top plate 20. The blade 30 is vertically coupled to the periphery of the top plate 20, and is detachable to the top plate 20. The lengths of the top plate 20 and the blade 30 is 3.15 inches respectively, and the height of the blade 30 is 1.18 inches.

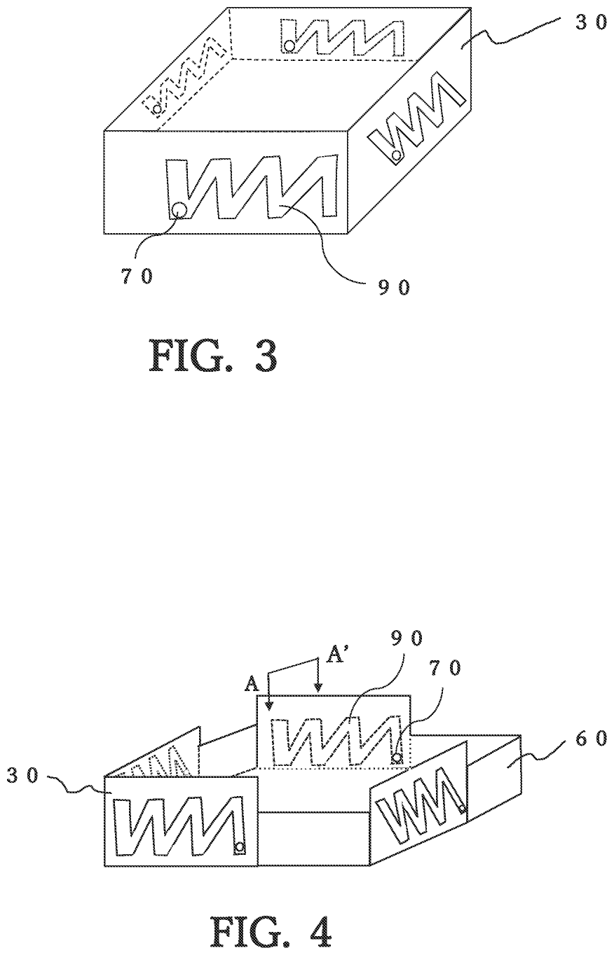

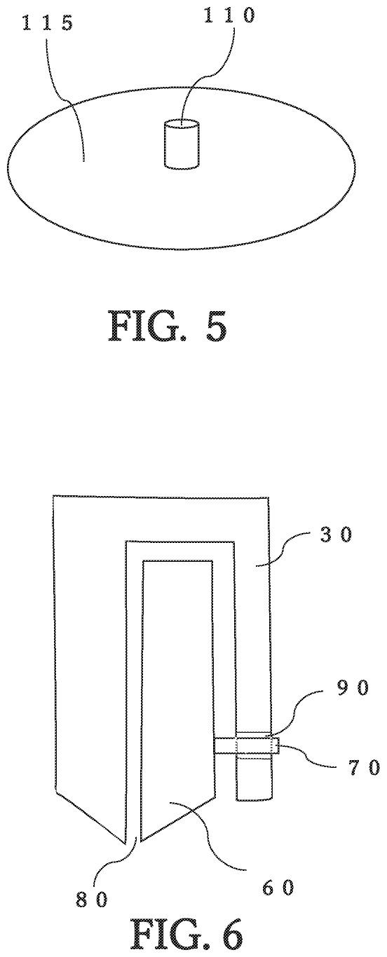

FIG. 2 and FIG. 3 are views of the top panel 20 and the blade 30, respectively, which are disassembled from the crust cutter 100 shown in FIG. 1. As shown in FIG. 2, a recess 40 is formed approximately in the center of the back side of the top plate 20. A mold 115 shown in FIG. 5 can be attached to the recess 40 by inserting the convex 110 into the recess 40 in order to cut the bread into the shape of the mold 115.

The attached mold 115 can be of any shape, but a child will be pleased if it is, for example, shaped like a famous character. The sharp edge of the mold 115 also allows the bread to be die-cut out. The recessed 40 is a square shaped whose one side is 0.79 inches. The outer periphery of the top panel 20 is formed with a groove 50 for the blade 30, and the blade 30 can be installed in the top panel 20 by inserting it into groove 50.

The blade 30 can be easily detached from the groove 50 in the top panel 20 when the blade 30 is extended or when the mold 115 is attached to the recess 40. FIG. 3 shows the blade 30 being detached. For the safety reasons, while the crust cutter is used in the state that the blade 30 is stored in the top plate 20, it is not necessary. Since the height of the blade 30 is set at 1.18 inches, the blade 30 can be used for cutting the crusts independently. While one end of the blade 30, which is in direct contact with the crust, is formed at an acute angle, the other end, which is stored in the groove 50, is formed at an obtuse angle and will not cut when touched by hand. The blade 30 includes an extendable blade, which is not illustrated in FIG. 3 but explained by using FIG. 4, an adjustment screw 70 and through holes 90, which are explained later using with FIG. 4 and FIG. 6.

The relationship between the blade 30 and the extendable blade 60 is explained as follows with using FIG. 4 and FIG. 6. As shown in FIG. 4 the extended blade 60 stored in the blade 30 can be pulled out of the blade 30. FIG. 6 shows an enlarged a cross-sectional view of the extendable blade taken along the line A-A′ shown in FIG. 4. As shown in FIG. 6, the blade 30 includes slit 80 inside, and the extendable blade 60 is stored in the slit 80 of the blade 30. The extendable blade 60 can be extended from and retracted in slit 80, so that a maximum movable area of the extendable blade 60 of 5.07 inches per side. The adjustment screw 70 is formed on the outer surface of the extendable blade 60. A part of the adjustment screw 70 protrudes into the slit 80. Therefore, the adjustment screw 70 can be moved from outside the slit 80. Since the extension blade 60 is lower in height than that of the blade 30, the adjustment screw 70 may be enough to move up and down in the through holes 90. The adjustment screw 70 may be gotten stuck at predetermined locations. In this preferred embodiment, there are five locations. Each location is spaced with 0.39 inch. As described, the adjustment screw 70 could be moved in the through holes 90. The blade 30 does not fit the size of the top panel 20 when the extendable blade is used, it is necessary to remove the blade 30 from the top panel 20 before using the extendable blade 60.

According to the present invention, the standard setting is adjusted to the minimum size of the average while bread so that it can be used for any size of bread. Further, the extendable blade 60, which can be extended and retracted, is installed so that it can be used for the maximum size of the while bread. Therefore, it can remove the crusts of the bread without being limited to the size of the bread, and can be used for both square and rectangular breads.

The bread crust cutter 100 with the extendable blade of the present invention is used as follows. In order to cut the crust, it is performed by grasping the handle 10, placing the bread on a flat surface and pressing the top plate 20 from the above. The initial length is set at 3.15 inches long and square, namely the size of the blade 30. In order to apply it to the large breads, the extendable blade 60 stored in the blade 30 is pulled out from the slit 80 of the blade 30. As described above, one side can be adjusted up to 5.07 inch. Since four though holes 90, each of which is the same shape and is formed at the same location, are formed in each side of the blade 30 and four adjustment screws 70, each of which is formed at the same location, are formed in each side of the extendable blade 30 respectively, the crush cutter can be formed in square shape, or rectangular shape. In each through hole, a plurality of stopper regions, in which the adjustment screw 70 stays, is formed. In addition, all components of the crust cutter of the invention are mode of plastics.

While the invention has been described with reference to illustrative embodiments, this description is not intended to be construed in a limiting sense. Thus, shapes, size and physical relationship of each component are roughly illustrated so the scope of the invention should not be construed to be limited to them. Further, to clarify the components of the invention, hatching is partially omitted in the cross-sectional views. Moreover, the numerical description in the embodiment described above is one of the preferred examples in the preferred embodiment so that the scope of the invention should not be construed to limit to them.

Various other modifications of the illustrated embodiment will be apparent to those skilled in the art on reference to this description. Therefore, the appended claims are intended to cover any such modifications or embodiments as fall within the true scope of the invention.

We claim:

1. A crust cutter having an extendable blade, comprising:
a top plate having a groove at its outer periphery, and having a recess formed in the back surface of the top plate
a handle attached to the top surface of said the top plate;
a blade insertable to the groove wherein the shape of the blade is the same as that of the top plate; and
an extendable blade being stored in the blade, the extendable blade being able to pull out from the blade.

2. A crust cutter having an extendable blade, as claimed in claim 1, further comprising: a mold having a convex connectable to the recess, the mode having at one end with an acute angle.

3. A crust cutter having an extendable blade, as claimed in claim 1, wherein the top plate, the handle, the blade, and the extendable blade are formed of plastic.

4. A crust cutter having an extendable blade, as claimed in claim 1, wherein the blade incudes a slit, where the extendable blade is stored.

5. A crust cutter having an extendable blade, as claimed in claim 1, wherein the blade incudes an elongated though hole on its surface, and the extendable plate includes an adjustable screw, which is engaged in the elongated through hole.

6. A crust cutter having an extendable blade, as claimed in claim 5, wherein the elongated though hole includes a plurality of stopper regions in which the adjustment screw stays.
